(19) United States
(12) Patent Application Publication
(10) Pub. No.: US 2014/0373320 A1
(43) Pub. Date: Dec. 25, 2014

(54) SAFETY CARABINER COMPRISING A DOUBLE GATE

(71) Applicant: Grivel S.r.l., Courmayeur (IT)

(72) Inventor: Miroslav Nemec, Dolni Bojanovice (CZ)

(21) Appl. No.: 14/376,180

(22) PCT Filed: Feb. 4, 2013
(86) PCT No.: PCT/EP2013/052184

§ 371 Date: Aug. 1, 2014

(30) Foreign Application Priority Data
Feb. 3, 2012 (CZ) PV2012-87

(51) Int. Cl. F16B 45/02; A63B 29/02

(52) U.S. Cl. CPC F16B 45/02; A63B 29/02
USPC 24/599.6

(57) ABSTRACT

A carabiner (1) is provided comprising a substantially C-frame (2) having a first end (3) and a second end (4), at least an internal gate (5) and an external gate (6). The frame (2) the internal gate (5) and the external gate (6) define a continuously enclosed inner region (8) in a closed configuration. Each of the gates (5, 6) has a pivot (5h, 6h) on one of the first and second end (3, 4). The gates are configured so as to be opened with respect to the frame (2) in view of a rotation about the respective pivot (5h, 6h), one in a first direction towards the inner region (8) and one in a second direction opposite to the first direction. Biasing means (5b, 5c, 6b, 6c) are provided to bias the gates in a closed position. Preferably the internal gate (5) is pivotably coupled to the frame at a first end (3) and the external gate (6) is pivotably coupled to the frame (2) at the second end (4) opposite to the first end (3). The carabiner includes an interstitial region (9, 209, 210) to receive at least a portion of a user's finger so as to facilitate the opening of the gates

### FIELD OF THE INVENTION

The invention relates to a mechanical coupling mechanisms such as carabiners and snap-hooks. In particular, the invention relates to an improved carabiner system.

### BACKGROUND OF THE INVENTION

A carabiner or a mountain carabiner or a safety carabiner is a mechanical device used to link rope, slings and other climbing aids together. A carabiner is essentially a snap-hook used, for example, to attach a climber's body harness to the climbing rope. It is also used to link the climbing rope to anchors placed in or over the rock.

A typical carabiner is a palm sized, oblong or oval or “D” shaped ring of a lightweight, high strength material, usually a heat-treated aluminum alloy.

Carabiners, also called snap-hooks or releasable clamps, are used in a variety of applications for releasably coupling objects to one another. For example, a rock climber may use one or more carabiners to releasably secure a rope to a protection device during vertical ascension. Carabiners generally include an open frame, a hinged arm that serves as an inward opening gate or lock, and a releasable gate closure mechanism.

The gate or lock is spring loaded to remain normally closed. The normally closed, inward opening gate facilitates insertion of climbing aids, but it should avoid inadvertent removal. Objects are released from the carabiner after manually pushing open the gate.

The frame and the gate are configured to form a continuous inner region which can couple to one or more objects.

The gate or lock engages the frame to form the continuous inner region.

The releasable gate closure mechanism is configured to allow the gate to be selectively pivoted with respect to the frame to facilitate addition or removal of items from the continuous inner region.

The gate is pivoted in an open position by pushing the gate with a finger while holding the frame with the other fingers or the other hand.

The releasable gate closure mechanism simultaneously biases the gate toward a closed configuration with respect to the frame so as to maintain mechanical coupling of items within the continuous inner region.

A wide variety of frame, gate, and biasing systems exist for particular applications.

The most used gates are wire-gates or revolving gates or revolving hinges.

Wire-gate type carabiners represent a particular gate construction, biasing system, and gate-frame interface.

Wire-gate carabiners utilize a substantially elongated, looped rigid wire member for the gate portion of the carabiner system.

In the wire-gate the lengthwise ends of the wire member gate are oppositely coupled to the frame such that the spring/rebound rigidity of the gate creates the automatic biasing mechanism.

As the gate is selectively pivoted about the frame coupling point, the torsional properties of the wire automatically generate a biasing force that mechanically urges the gate back toward the closed configuration.

The frame includes a gate interface region which generally includes a hook over which the loop of the gate is configured to extend while in the closed configuration.

Revolving gate or hinge carabiners generally include an hinge coupled to the frame through a mechanism comprising a stout compression that is housed within the gate. The spring urges the gate back toward the closed configuration.

The opening end of the gate incorporates a transverse pin that engages a hooked notch in the carabiner frame when the gate is completely closed. This arrangement allows the gate to carry part of the load imposed on the carabiner.

Consequently, the carabiner is significantly stronger when the gate is closed.

A variety of specialized carabiner designs are configured to include specific mechanical characteristics that optimize particular functionalities.

A problem that generally occurs in the above described carabiners is the accidental opening of the gate due to the fact that the rope may get jammed into the gate if external forces are exerted for example when the climber falls. This can cause an accidental opening of the gate and can therefore cause serious accidents. Whenever the gate opens, even momentarily, there is a significant risk that a rope or other climbing aid will be inadvertently released.

Since carabiners are human safety device, each possible cause of malfunctioning can cause serious and even mortal accidents.

Different technical solutions have been improved in carabiners to avoid such problems.

A first known type of specialized carabiner is the so called screw carabiner. In the screw carabiner the gate integrates a screwable portion that can be screwed along the length of the gate, either toward the hinge, or toward the opening end directly onto a corresponding coupling portion of the frame.

The user can screw and unscrew the gate with one hand in order to lock or release the gate while holding the carabiner with the other hand.

The screw carabiner lowers the risks of an accidental opening of the carabiner, but it does not totally eliminate them because the rope can unscrew the carabiner. Moreover it requires that the user act with two hands, while in many situations the user cannot safely use the two hands contemporarily without taking some risk. The climber can be in the need of using only one hand to firmly hold the rock and use the carabiner with a single hand. The professional user can also have one tool in one hand and therefore can use the carabiner only with one hand.

Moreover the screw mechanism increases the weight of the carabiner and can become clogged with dirt, sand and ice.

As a possible alternative to the screw carabiner, it has been also been proposed to use the so called twist lock carabiner to include a spring lock that urges the gate to rotate in order to engage a corresponding coupling portion of the frame so that the gate locks automatically.

Unfortunately it has been verified that a rope and also bolts and hangers can become clogged in the locking system and/or can involuntary rotate the twisting gate and open the carabiner causing again serious accidents.

Moreover all known carabiners have to be opened with two hands and a carabiner that need two hands to be opened still present the above safety issues.

There is the need in the market of a carabiner which avoids all the safety problems connected to a possible involuntary opening of the locking mechanism and allows a safe locking mechanism with a single hand and is possibly lightweight, easy to manufacture and to be maintained and that it cannot become clogged.

### SUMMARY OF THE INVENTION

According to the present invention the above mentioned problems are solved by a carabiner according to claim 1.

### BRIEF DESCRIPTION OF THE DRAWINGS

FIG. 1 illustrates a frontal view of a carabiner according to a first embodiment of the present invention in a first totally closed configuration;

FIG. 2 illustrates a frontal view of a carabiner according to a first embodiment of the present invention in a second partially internally closed configuration;

FIG. 3 illustrates a frontal view of a carabiner according to a first embodiment of the present invention in a third partially externally closed configuration;

FIG. 4 illustrates a frontal view of a carabiner according to a first embodiment of the present invention in a fourth totally open configuration;

FIG. 5 illustrates a frontal view of a carabiner according to a second embodiment of the present invention;

FIG. 6 illustrates a frontal view of a carabiner according to a third embodiment of the present invention;

FIG. 7 illustrates a frontal view of a carabiner according to a fourth embodiment of the present invention;

FIG. 8 illustrates a frontal view of a carabiner according to a fifth embodiment of the present invention;

FIG. 9 illustrates a first lateral view of a carabiner according to a sixth embodiment of the present invention in a closed configuration;

FIG. 10 illustrates a second lateral view of the carabiner of FIG. 9;

FIG. 11 is a section of the carabiner of FIG. 9; and

FIG. 12 is a perspective view of the carabiner of FIG. 9.

### DETAILED DESCRIPTION OF THE INVENTION

As defined in the present invention a carabiner is a mechanical device including a frame, at least a gate, and an inner region defined between the frame and the at least one gate.

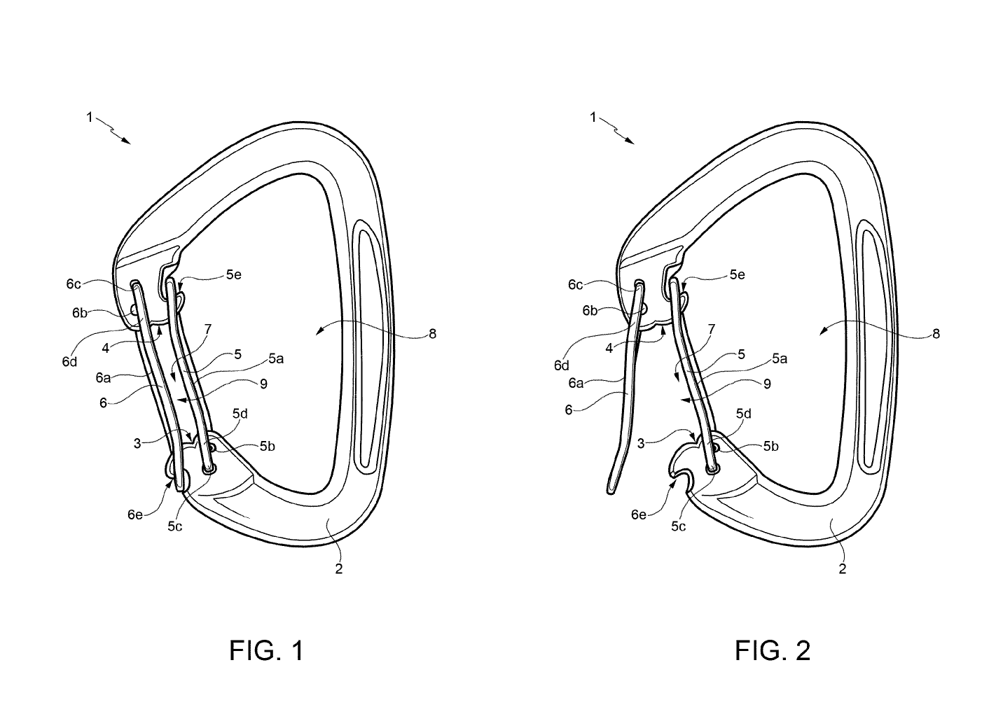

With reference to FIGS. 1 to 4 in a first embodiment according to the present invention a carabiner is provided including a frame 2 having a first end 3 and a second end 4 opposite and substantially facing the first end 3, a first internal gate 5 and a second external gate 6 extending substantially parallel to the first internal gate 5 and externally to it with respect to the inner region 8 defined by the frame and the gates 5, 6.

In particular the carabiner 1 comprises a frame (2) partially enclosing an inner region 8 and having a first end 3 and a second end 4, a first gate 5 pivotably coupled to the frame at said first end 3 and a second gate 6 pivotably coupled to said frame 2 at said second end 4 opposite to the said first end 3; said frame, said first gate and said second gate define a continuously enclosed inner region 8 in a closed configuration as illustrated in FIG. 1; said gates being configured so as to be opened with respect to said frame by rotating about the respective pivot 5h, 6h, one in a first direction towards said inner region and one in a second direction opposite to said first direction, biasing means 5b, 5c, 6b, 6c being provided to bias said gates in a closed position.

In detail, each of the gates 5, 6 has a pivot 5d, 6d on one of the first and second end 3, 4. The gates 5, 6 are configured so as to be opened with respect to the frame 2 in view of a rotation about the respective pivot 5d, 6d, one in a first direction towards the inner region 8 and one in a second direction opposite to the first direction. Biasing means 5b, 5c, 6b, 6c are provided to keep the gates in a closed position.

Only if the two gates 5, 6 are opened in opposite directions the carabiner is safe, otherwise the carabiner would work as a single gate carabiner similarly to the prior art and with the same problems.

Both gates may be pivoted with respect to the frame 2 about a pivot region to form a totally open configuration illustrated in FIG. 4.

The gates 5, 6, are pivoted in an open position by pushing the gates 5, 6 with one or more fingers while holding the frame 2 with the other fingers or the other hand.

Between the first internal gate and the second external gate is present an interstitial region 9, to receive at least a portion of a user's finger so as to facilitate the opening of the gates.

In the embodiment of FIG. 1, the interstitial region 9 is a through region.

The interstitial region 9 can also be constituted by a different shape of the wire designed to better interact with the finger's user.

The interstitial region 9 allows to open the carabiner with a single hand because there is enough space between the gates to insert a finger and exert a pressure in order to open the external gate 6 with a single finger. If there is not enough space and the two gates are close to each other the opening of the gates is difficult and the carabiner does not work properly.

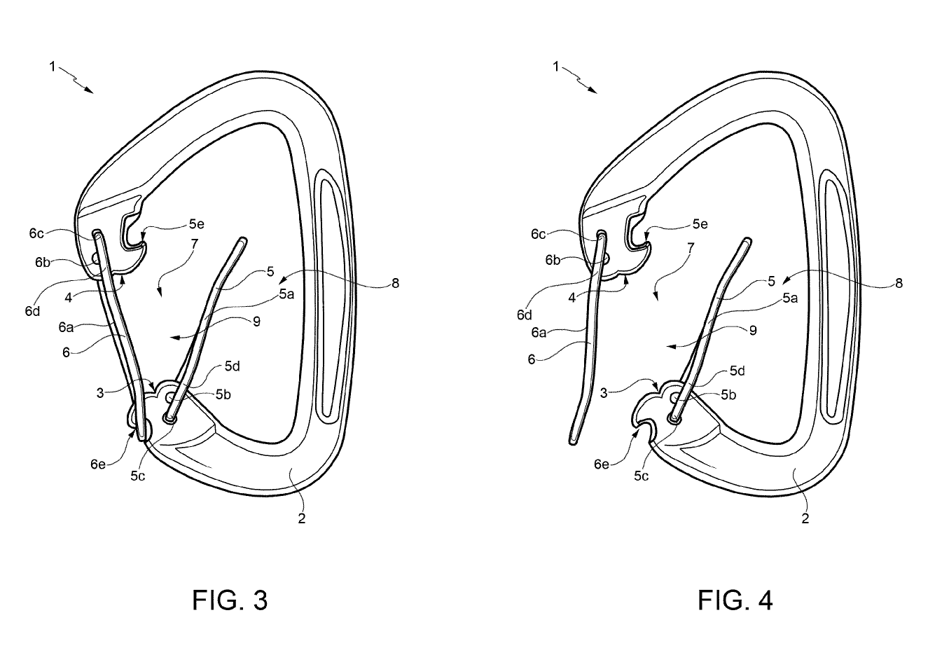

By opening the external gate the first gate 5 pivots around a pivot region 5d toward the inner region 8 with respect to the frame to create a first partially open configuration also illustrated in FIG. 3.

In this configuration the inner region 8 is defined by the frame 2 and the external gate 6, whilst the internal gate 5 extends toward the inner region 8.

The external gate 6 is pivotable around a pivot region 6d but toward an external region in a direction opposite to the internal region 8 and outside the inner region 8 defined by the frame 2 and both the gates 5, 6 in the totally closed configuration.

“Pivotable” means that two components are coupled in a manner that facilitates a pivot type movement therebetween. For example, a door is pivotably coupled to a door frame to facilitate pivotal rotation about the door frame.

When the external gate 6 is pivoted and open and the internal gate 5 is closed the carabiner 1 is in a second partially open configuration also illustrated in FIG. 2.

The user generally opens the external gate 6 with one finger inserting it in the interstitial region 9 while holding the frame with the other fingers and therefore operates with a single hand. Contemporarily the rope or another safety object is inserted in the inner region 8 by pushing it with another finger against the inner gate 6. The inner gate when pushed automatically opens toward the inner region 8.

Preferably the shape of the two gates 5, 6 is made to allow an easy insertion of the rope or another safety object and therefore preferably the gates 5, 6 are generally rounded and not edged.

When the external gate 6 is pivoted and open and the internal gate 5 is also open the carabiner 1 is in a totally open configuration also illustrated in FIG. 4, a position in which a rope or another safety object can be easily inserted in the carabiner 1.

Both the internal gate 5 and the external gate 6 comprise a gate biasing system 5b, 5c, 6b, 6c, i.e. a system of components configured to bias the gate of a carabiner toward a particular configuration or biasing system.

Both the first gate 5 and the second gate 6 are biased by the above gate biasing system 5b, 5c, 6b, 6c, or close mechanism system toward a closed configuration in which the inner region 8 is continuous with regards to being enclosed by the frame and the gate.

“Biased” means that the gate is urged toward a particular configuration, this means that if it is stretched and released, it will return to the biased configuration.

Preferably the biasing system is constituted by a portion of the wire.

More preferably the biasing system is constituted by flexural means.

In the carabiner of the present invention both the internal gate 5 and the external gate 6 are biased to rotate in order to engage a corresponding coupling portion of the frame so that the gate locks automatically in corresponding keyed regions 5e, 6e of the frame that may also be referred to as the nose of the carabiner system.

In a first preferred embodiment illustrated in FIG. 1 both the internal gate 5 and the external gate 6 may be referred to as wire-type gates in that the gates are constituted by an arch 5a, 6a comprising two respective ends 5b, 5c and, respectively, 6b, 6c.

The term wire may broadly include various compositions such as metal and cross-sectional shapes such as circular. The wire forming the internal gates 5 and the external gate 6 is bent into a particular lengthwise shape includes a curved region of more than ninety degrees.

In the illustrated embodiments, the gate biasing system is incorporated within the coupling scheme and composition of the internal gate 5 and external gates 6. The two lengthwise ends 5b, 5c of the internal gate 5 and the two lengthwise ends 6b, 6c of the internal gate 6 are coupled to the frame 2 at two independent gate attachment points (not illustrated) and are oriented opposite one another with respect to the lengthwise orientation of the frame structure 2. The spacing and opposite orientation of the lengthwise ends in combination with the overall shape of the gates 5, 6 result in a torsional force on the gates 5, 6 when selectively pivoted into the open configuration.

The inherent torsional rigidity and/or composition properties of the gates 5, 6 generate a rebound or spring response force which biases/pivots the gate back toward the closed configuration. It will be appreciated that various alternative gate biasing systems may also be utilized in accordance with the present invention including, but not limited, to the inclusion of one or more spring mechanisms.

The frame 2 can be made in various materials, preferably metal, more preferably steel or aluminum and is generally shaped in a lengthwise curved C-shaped configuration.

The shaping and composition of the frame 2 is generally adjusted to respond to particular exigencies such as weight and strength.

An opening 7 is disposed between the pivot regions 5d, 6d of the two gates, which also correspond to the two lengthwise ends of the kidney shaped or C-shaped frame 2 and in the embodiment of FIG. 1 corresponds to the interstitial region 9. The keyed regions 5e, 6e are conformed as hooks, i.e. a structure oriented substantially toward the inner region 8 of the frame 2.

The gate wire is an elongated member which is of a metal material having particular torsional rigidity properties necessary for the gate biasing system. In addition, the wire gates 5, 6 are shaped in a particular lengthwise and cross-wise configuration to releasably couple with the frame 2 at the keyed regions 5e, 6e in the closed configuration, i.e. the wire-gates 5, 6 are specifically keyed/sized so as to be selectively disposed over the hooks of the frame 2 to engage a releasable coupling in at least one two dimensional plane in the closed configuration.

The gates wire 5, 6 are routed through separate corresponding gate attachment points 5b, 6b in the frame 2 respectively, so that the coupling operates to effectuate a automatic gate biasing force in response to pivoting the gates 5, 6.

The opening region 7 is closed by the two opposite forces exerted by the two gates 5, 6. The opposite forces exerted on the two opposite keyed regions 5e, 6e of the frame prevent an accidental opening of the carabiner 1.

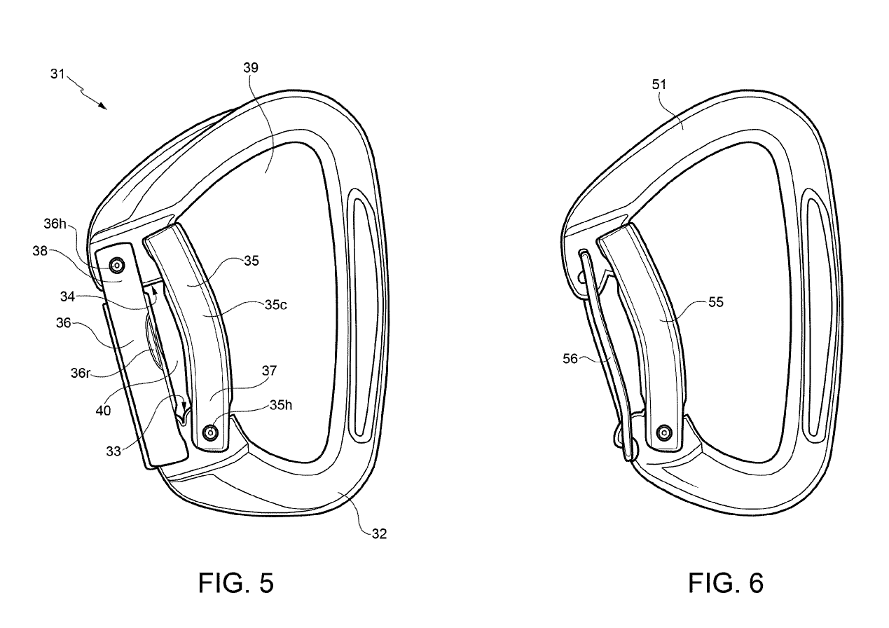

In FIGS. 5 to 9 are illustrate alternative embodiments of the present invention.

In a second embodiment a carabiner 31 as illustrated in FIG. 5 is provided, wherein the two wire gates 5, 6 of the first embodiment have been substituted with two revolving or hinge gates 35, 36.

The carabiner 31 comprises a frame 32 comprising two opposite ends 33, 34.

As above described, the revolving or hinge gates 35, 36 include respective pivot 35h, 36h coupled to the frame 32 through a biasing system 37, 38 at the two opposite ends 33, 34. The frame 32 and the two gates 35, 36 define an internal region 39 when the two gates are in a closed configuration. The biasing system 37, 38 comprises a mechanism comprising a stout compression spring that is housed within the gate(internal and not visible in the figure). Similarly to the above illustrated biasing system of the wire gate, the biasing system of the stout compression spring urges the gates 35, 36 back toward the closed configuration.

The opening end of the revolving or hinge gates 35, 36 incorporates a transverse pin that engages a hooked notch in the carabiner frame 32 when the gates are completely closed. This arrangement allows the gate to carry part of the load imposed on the carabiner 1. Consequently, the carabiner is significantly stronger when both gates are closed.

According to the second embodiment the two revolving or hinge gates 35 and 36 are different and the internal gate 35 is curvilinear and in particular is curved toward the internal region 39 so that an interstitial region 40 constituted by a space is formed similarly to the interstitial region 9 of the first embodiment to allow a finger to be inserted in order to facilitate the opening the gates.

As an alternative or as a further interstitial region, the hinge gate can have a wider section in correspondence of one end or be tapered or include a winglet at one of his ends or a concave region preferably at about the center of his length.

The hinge gate can also have one or more interstitial region 40.

The second external gate 36 comprise also a central concave region 36r not only being and working as an interstitial region for the finger but also designed to further facilitate the insertion of a rope or a safety object.

In use the carabiner may be opened and closed identically to the carabiner 1 of the first embodiment.

The user opens the first external gate 36 with one or more finger inserting a finger in the interstitial region 40 while holding the carabiner 31 with the other fingers. Successively the user pushes a rope or a safety device against the internal gate 35. The internal gate 35 opens in an opposite direction with respect to the external gate 36 toward the inner region 39.

According to a third embodiment a carabiner 51 is provided as illustrated in FIG. 6 wherein the first internal gate 55 is a concave revolving or hinge gate and the external gate 56 is a wire gate 56.

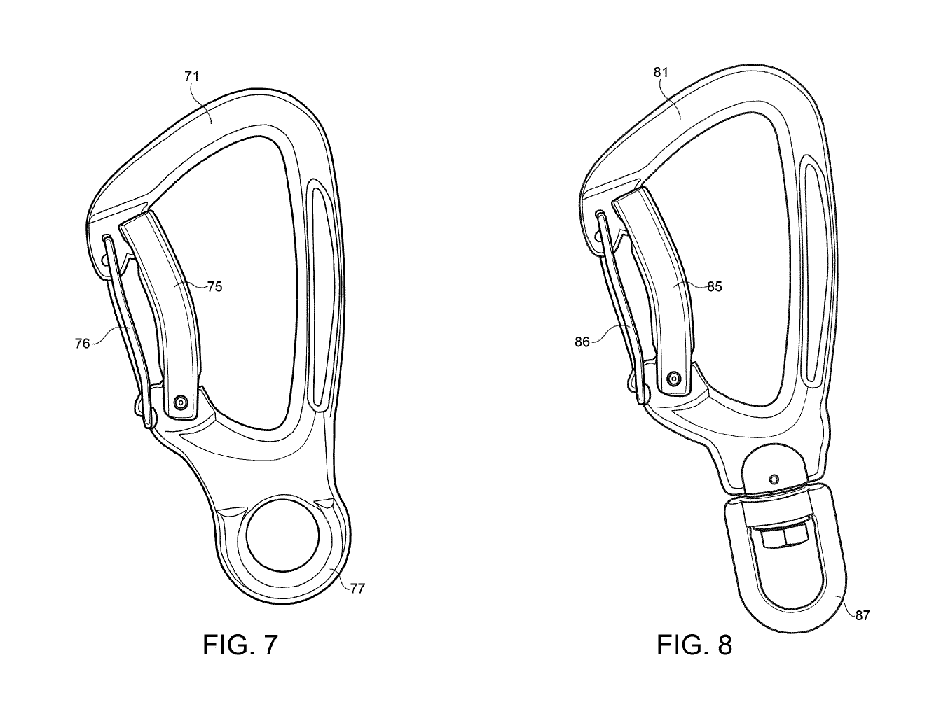

In FIGS. 7 to 8 are illustrated a fourth and a fifth embodiments of the carabiner of present invention where the frame 71 have different shapes and, respectively, a frame comprising a further fixed ring 77 and respectively a rotatable ring 87 associated to the kidney frame carabiner 71 and respectively 81.

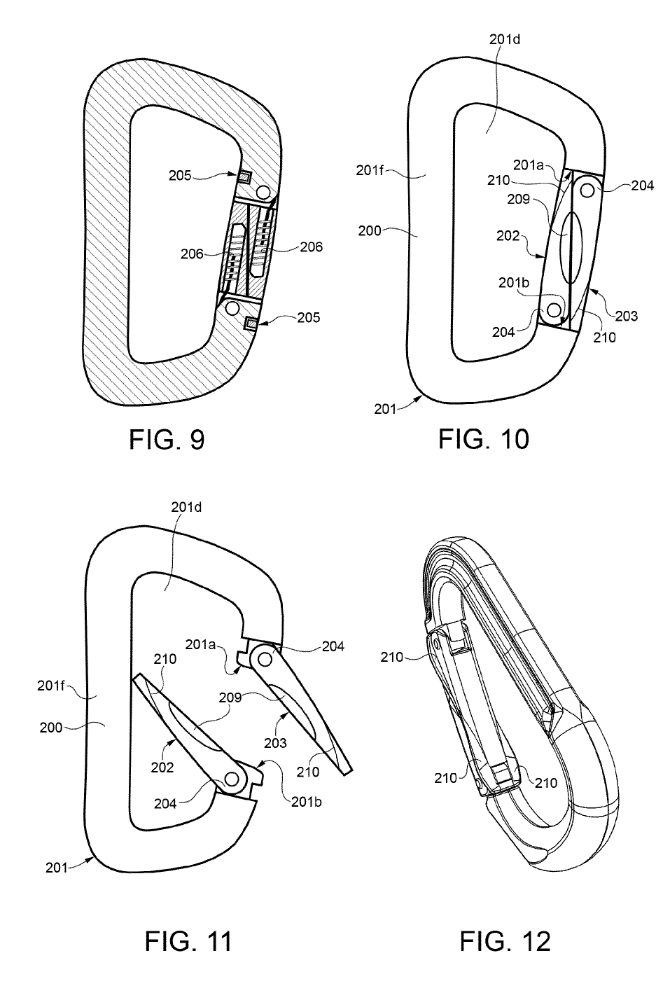

In FIG. 9 is illustrated a sixth embodiment of the present invention wherein a carabiner or snap-hook 201 has also a double lock or double gate and comprises a frame 201b.

As illustrated in FIG. 10 the carabiner 201 is formed by a kidney-shaped body 201 comprising two ends 201a and 201b. At each end is hinged an inside or internal gate 202 and an outside or external gate 203.

The body 201 of the carabiner is made of light solid metals used in majority of usual carabiners. The opening system or lock of the carabiner is formed of the internal gate 202 and external gate 203 so that the bodies of both latch-locks mutually touch and are in contact along one side of their bodies in the locked or closed position, as illustrated in the FIGS. 10 and 11. A bias is created by the pressure of a spring 206 integrated in the internal gate 202 and in the external gate 203 of the carabiner 200. Securing position of the gates in the locked position is formed by the opposing safety bolts 205 as illustrated in the section of FIG. 16. At the same time and as a further advantage the opposing safety bolts 205 increase strength of the snap-hook in its main axis.

According to this embodiment the gates 202, 203 comprise a concave region 209 as interstitial region provided on one lateral side of both gates 202, 203.

The concave region 209 allows a finger to be inserted and allow the opening of the gates by exerting a pressure on the concave region 209 through a single finger.

As a further or as an alternative the gates 202, 203 may also have a different shape as an interstitial region.

As illustrated in FIGS. 9 to 11 the gates 202 and 203 may present a winglet 210 on ends opposite to the end fixed to the frame. The winglet 210 protrude from the profile of the gates 202 and 203 and form an interstitial region to facilitate a finger to be inserted and to open the gates.

In FIG. 11 is illustrated the open position of the double gates 202, 203. Connection of internal gate 202 of the carabiner 200 and external gate 203 of the carabiner 200 with body of the carabiner 200 is formed of two opposite revolving hinges 204 in heels of both locks. Intentional mechanical pressure of human hand fingers opens double gates 202, 203 of the carabiner by deflection of both locks in hinges so that internal gate 202 opens inwards the carabiner 200 body and external gate 203 opens outwards the carabiner 200 body 201. Releasing intentional mechanical pressure of human hand to locks or removing an object (usually climbing rope) from the middle of locks, causes that both internal gate 202 and external gate 203 get automatically into locked position thanks to pressure of the springs 206 integrated in the openings 202, 203.

The carabiner of the present invention are particularly indicated for the use in climbing, in building, in industry and in navy.

It should be noted that while different embodiments of the present invention have been above described with reference to different carabiner according to the embodiments described above, the teachings of the present invention are applicable also to other gate carabiners.

1. Carabiner comprising a frame partially enclosing an inner region and having a first end and a second end, a first gate pivotably coupled to the frame at said first end and at least a second gate pivotably coupled to said frame at said second end opposite to the said first end; said frame, said first gate and said second gate define a continuously enclosed inner region in a closed configuration; said gates being configured so as to be opened with respect to said frame by rotating about the respective pivot, one in a first direction towards said inner region and one in a second direction opposite to said first direction, biasing means being provided to bias said gates in a closed position.

2. Carabiner according to claim 1, wherein the carabiner includes at least an interstitial region to receive at least a portion of a user's finger so as to facilitate the opening of the gates.

3. Carabiner according to claim 1, wherein said interstitial region is a through region.

4. Carabiner according to claim 1, wherein said frame is kidney shaped.

5. Carabiner according to claim 1, wherein said gate biasing system is an automatic biasing mechanism.

6. Carabiner according to claim 1, wherein said first gate and/or said second gate are wire-gates or revolving gate or revolving hinge.

7. Carabiner according to claim 1, wherein said second gate is a wire gate.

8. Carabiner according to claim 4, wherein said gate biasing system comprises a portion of said wire.

9. Carabiner according to claim 1, wherein said biasing system comprises flexural means.

10. Carabiner according to claim 1, wherein said internal gate is a revolving hinge gate.

11. Carabiner according to claim 1, wherein said interstitial region is a concave region provided on one lateral side of at least one of said gates.

12. Carabiner according to claim 11, wherein said interstitial region is a winglet provided on one lateral side of at least one of said gates.

13. Carabiner according to claim 11, wherein said first gate and said second gate have in its top a safety bolt for securing locked position and an integrated spring.

14. Carabiner according to claim 11, wherein said first gate and said second gate are in contact with each other.

15. Use of a carabiner according to claim 1 in climbing, in building, in industry, or in navy.
